(19) United States
(12) Patent Application Publication
(10) Pub. No.: US 2025/0025968 A1
(43) Pub. Date: Jan. 23, 2025

(54) FLUX AND SOLDER PASTE COMPRISING SAID FLUX

(71) Applicant: Heraeus Electronics GmbH & Co. KG, Hanau (DE)

(72) Inventors: Michael NEIDERT, Hanau (DE); Steffen KÄSS, Hanau (DE); Christian LOOSZ, Hanau (DE)

(21) Appl. No.: 18/772,915

(22) Filed: Jul. 15, 2024

(30) Foreign Application Priority Data
Jul. 20, 2023 (EP) 23186571.8

(51) Int. Cl. B23K 35/36; B23K 35/02

(52) U.S. Cl. CPC B23K 35/3612; B23K 35/025; B23K 35/3613

(57) ABSTRACT

A flux consisting of, (i) 30 to 80 wt. % of one or more acidic resins, (ii) 10 to 60 wt. % of at least one organic solvent, (iii) 0 to 15 wt. % of one or more amines, and (iv) 0 to 20 wt. % of one or more components other than components (i) to (iii), wherein the flux undergoes a weight loss of ≥50 wt. % upon reaching a temperature of 280° C. during a thermogravimetric analysis carried out in the range from 25 to 350° C. at a heating rate of 10 K/min and with the addition of synthetic air; and solder paste consisting of 80 to 92 wt. % of one or more different solders and 8 to 20 wt. % of the flux.

### CROSS-REFERENCE TO RELATED APPLICATIONS

This application claims priority pursuant to 35 U.S.C. 119(a) to European Application No. 23186571.8, filed Jul. 20, 2023, which application is incorporated herein by reference in its entirety.

### FIELD OF THE INVENTION

The present invention relates to a flux for solder pastes and to a solder paste comprising the flux, in particular for attaching electronic components to substrates.

### BACKGROUND OF THE INVENTION

Solder pastes, in particular soft solder pastes, are mainly used in the production of electronic circuits and are used to create a mechanical, electrical and thermal connection between an electronic component and a substrate, or more precisely, between the contact surfaces of the latter intended for this purpose.

Examples of electronic components within the meaning of the present patent application include diodes, LEDs (light emitting diodes), dies, IGBTs (insulated-gate bipolar transistors), MOSFETs (metal-oxide-semiconductor field-effect transistors), ICs (integrated circuits), sensors, heat sinks, resistors, capacitors, coils, connecting elements (e.g., clips), base plates, antennas and the like.

Examples of substrates within the meaning of the present patent application include lead frames, PCBs (printed circuit boards), flexible electronics, ceramic substrates, metal-ceramic substrates, such as DCB substrates (direct copper-bonded substrates), IMS (insulated metal substrates) and the like.

The electronic component is typically brought into contact with or applied to the substrate via the solder paste. The solder paste is heated in order to melt the solder (solder metal, solder alloy) in the paste by means of a reflow process, for example. After the solder has cooled and solidified, the electronic component and substrate are firmly bonded together.

In addition to solder powder, solder pastes typically contain fluxes. Fluxes are used, among other things, to dissolve the oxide layer on the surfaces of the solder powder, the electronic component and the substrate and thus ensure better wettability during the soldering process.

Fluxes that form part of solder pastes are typically based on natural resins, such as colophony in particular. Furthermore, organic solvents, buffering bases, such as amines, and activators, such as carboxylic acids or halogen compounds, are typically contained as components in such fluxes.

The task of the invention is to provide a solder paste having the lowest possible rate of defects, such as gas or air inclusions, in the form of voids in solder joints produced from the solder paste. The solder paste to be found should also have good solderability in the presence of air, i.e., without having to take special measures to exclude atmospheric oxygen, such as vacuum soldering or soldering under inert gas.

The applicant was able to develop a flux that solves the problem, or rather a solder paste comprising the flux that solves the problem. Accordingly, the invention consists in providing a flux consisting of
(i) 30 to 80 wt. % (% by weight), preferably 40 to 70 wt. %, of one or more acidic resins,
(ii) 10 to 60 wt. %, preferably 20 to 50 wt. %, of at least one organic solvent,
(iii) 0 to 15 wt. %, preferably 4 to 12 wt. %, of one or more amines, and
(iv) 0 to 20 wt. % of one or more components other than components (i) to (iii),
   wherein the flux is characterized in that it undergoes a weight loss of ≥50 wt. % upon reaching a temperature of 280° C. during a thermogravimetric analysis (TGA) carried out in the range from 25 to 350° C. at a heating rate of 10 K/min and with the addition of synthetic air.

Depending on the presence of components (iii) and/or (iv), the flux according to the invention may accordingly consist of components (i) plus (ii) or (i) plus (ii) plus (iii) or (i) plus (ii) plus (iv) or (i) plus (ii) plus (iii) plus (iv) and in each of these alternatives the sum of the wt. % of the respective components is 100 wt. %.

The flux according to the invention comprises as component (i) 30 to 80 wt. %, preferably 40 to 70 wt. %, of one or more acidic resins. The one or more acidic resins may be selected from the group consisting of acidic oligoesters and acidic (meth)acrylic copolymers. “(Meth)acrylic” means “methacrylic” and/or “acrylic.” The acidic oligoesters and the acidic (meth)acrylic copolymers are each in particular carboxyl-group-bearing resins, i.e., resins which owe their acidic character to their carboxyl groups.

### BRIEF SUMMARY

In a first embodiment, component (i) of the flux according to the invention consists of one or more acidic resins in the form of one or more different acidic oligoesters.

In a second embodiment, component (i) of the flux according to the invention consists of one or more acidic resins in the form of one or more different acidic (meth)acrylic copolymers.

In a third embodiment, component (i) of the flux according to the invention consists of a combination of one or more acidic oligoesters and one or more acidic (meth)acrylic copolymers.

### DETAILED DESCRIPTION

The acidic oligoester(s) mentioned herein as possible components (i) have an acid number in the range from 150 to 300 mg KOH/g and a weight-average molecular weight Mw in the range of 300 to 600. Preferred are acidic oligoesters having an acid number in the range from 200 to 250 mg KOH/g and having a weight-average molecular weight Mw in the range from 400 to 550. Particularly preferably, it concerns only one acidic oligoester having an acid number in the range from 200 to 250 mg KOH/g and having a weight-average molecular weight Mw in the range from 400 to 550. A distinction is made here between one acidic oligoester and several different acidic oligoesters. To avoid any misunderstanding, the term “an acidic oligoester” refers to a mixture of oligomers or an oligomeric polyester having a qualitatively and quantitatively defined structure, i.e., with a structure consisting of building blocks defined by type and quantity. As can already be seen from the weight-average molecular weight Mw, the “an acid oligoester” also has a molecular weight distribution, i.e., it is present as a mixture of oligomeric polyester molecules of different sizes. Accordingly, the term “several different acidic oligoesters” refers to a combination of different oligomer mixtures or to several differently structured oligomeric polyesters; each of these different oligomeric polyesters has a molar mass distribution.

The term “acid number” used in this description and in the examples refers to an acid number (SZ) that can be determined in mg KOH/g (milligrams KOH per gram) in accordance with DIN EN ISO 2114.

Unless otherwise stated, all standards cited in this description and in the examples are the version prevailing at the time of the priority date of the present patent application.

The weight-average molecular weight Mw mentioned in this description and in the examples can be determined in the usual manner known to the person skilled in the art by means of GPC, for example according to DIN 55672-1 (March 2016; crosslinked polystyrene as immobile phase, tetrahydrofuran as liquid phase, polystyrene standards, 23° C.).

The acidic oligoesters can be composed of one or more different low-molecular-weight polyols as hydroxyl building blocks and one or more different low-molecular-weight polycarboxylic acids as carboxyl building blocks.

The term “low-molecular-weight” used herein refers to compounds which are defined by their molecular and structural formula and which do not have a molar mass distribution.

The acidic oligoester(s) are preferably linear acidic oligoesters with one or two terminal carboxyl groups or a mixture of such oligoesters. The preferred linear acidic oligoesters can be composed of one or more different low-molecular-weight diols and one or more different low-molecular-weight dicarboxylic acids. Examples of low-molecular-weight diols include aliphatic and cycloaliphatic diols, such as ethylene glycol, 2-ethyl-1,3-hexanediol, 1,2- and 1,3-propylene glycol, 1,3-butanediol, 1,4-butanediol, 2,3-butanediol, 1,5-pentanediol, 1,6-hexanediol, trimethylhexanediol, hydrogenated bisphenols, cyclohexanediols, 1,4-cyclohexanedimethanol, neopentylglycol and butylethylpropanediol. Preferably, the low-molecular-weight diols are selected from the group consisting of low-molecular-weight cycloaliphatic diols. Examples of low-molecular-weight dicarboxylic acids include tetrahydrophthalic acid, maleic acid, fumaric acid, hexahydrophthalic acid, 1,3-cyclohexanedicarboxylic acid and 1,4-cyclohexanedicarboxylic acid, adipic acid, malonic acid, succinic acid, glutaric acid, pimelic acid, cork acid, azelaic acid, sebacic acid, undecanedioic acid, dodecanedioic acid and tridecanedioic acid. Preferably, the dicarboxylic acids are selected from the group consisting of aromatic dicarboxylic acids, such as the isomeric phthalic acids, especially orthophthalic acid.

Processes for preparing acidic oligoesters by polycondensation of low-molecular-weight polyols as hydroxyl building blocks and low-molecular-weight polycarboxylic acids as carboxyl building blocks are well known to the person skilled in the art, i.e., a synthetic resin or polymer chemist. In the polycondensation typically carried out in the melt, water is split off during an esterification reaction; the water is removed from the reaction mixture, in particular by distillation, possibly azcotropically or with support by applying a vacuum. Of course, instead of polycarboxylic acid-if available-corresponding acid anhydride can be used, which can be esterified with the hydroxyl building block(s) by opening the ring.

The acidic (meth)acrylic copolymer(s) mentioned herein as possible components (i) have an acid number in the range from 100 to 350 mg KOH/g, preferably from 150 to 300 mg KOH/g. Preferably, this concerns only one such acidic (meth)acrylic copolymer. The acidic (meth)acrylic copolymer(s) have a weight-average molecular weight Mw, for example in the range from 1000 to 3500 or preferably in the range from 1000 to 3000. Preferred are acidic (meth)acrylic copolymers having an acid number in the range from 100 to 350 mg KOH/g and having a weight average molecular weight Mw in the range from 1000 to 3500. Particularly preferred are acidic (meth)acrylic copolymers having an acid number in the range from 150 to 300 mg KOH/g and having a weight-average molecular weight Mw in the range from 1000 to 3000. These are copolymers of (meth)acrylic compounds which can be prepared in the usual manner known to the skilled person by radical copolymerization, it also being possible for the copolymers to comprise comonomers other than those of (meth)acrylic type, such as vinyl compounds and/or other olefinically unsaturated radically copolymerizable compounds, in a total proportion by weight of <50 wt. %, based on total acidic (meth)acrylic copolymer. Examples of the (meth)acrylic compounds which make up >50 wt. %, based on the total (meth)acrylic copolymer, are (meth)acrylic acid, (meth)acrylic acid esters and (meth)acrylamides. Examples of vinyl compounds include compounds such as vinyl ester, vinyl ether, styrene and the like.

It is preferred if the acidic (meth)acrylic copolymer(s) have a glass transition temperature (Tg) in the region of >0° C., but generally ≤105° C. The glass transition temperature can be determined using differential scanning calorimetry (DSC) based on DIN 51007 at a heating rate of 10 K/min.

Acidic (meth)acrylic copolymers of the type explained above are commercially available. Examples thereof include products by the name of Indurez from Indulor Chemie GmbH and products by the name of Joncryl® from BASF.

As component (ii), the flux according to the invention comprises 10 to 60 wt. %, preferably 20 to 50 wt. %, of at least one organic solvent. Examples include diols, alcohols, ether alcohols and ketones which are liquid at 25° C., in particular trimethylpropanol, 1,2-octanediol, 1,8-octanediol, 2,5-dimethyl-2,5-hexanediol, isobornylcyclohexanol, glycol ether, 2-ethyl-1,3-hexanediol, n-decyl alcohol, 2-methyl-2,4-pentanediol, terpineol and isopropanol as well as mixtures thereof. Examples of glycol ethers include mono-, di-, tripropylene glycol methyl ethers, mono-, di-, tripropylene glycol n-butyl ethers, mono-, di-, triethylene glycol n-butyl ethers, ethylene glycol dimethyl ethers, triethylene glycol methyl ethers, diethylene glycol dibutyl ethers, tetraethylene glycol dimethyl ethers and diethylene glycol monohexyl ethers, as well as mixtures thereof. To avoid misunderstandings, the diols mentioned here as examples relate to diols deliberately added as a type (ii) component when formulating the flux according to the invention. Said diols are not to be confused with any unintentional and unavoidable impurities in the flux according to the invention in the form of traces of diols used as hydroxyl building blocks in the synthesis of any acidic oligoester and not incorporated (not condensed) into the acidic oligoester.

As component (iii), the flux according to the invention comprises 0 to 15 wt. %, preferably 4 to 12 wt. % of one or more amines, i.e., the flux according to the invention may comprise one or more amines or be free thereof, preferably one or more amines are comprised. Examples of amines include N,N,N′,N′-tetramethylethylenediamine, N,N,N′,N′-tetraethylethylenediamine, N,N,N′,N′-tetrapropylethylenediamine, N-coco-1,3-diaminopropane, 1,6-diaminohexane, 1,7-diaminoheptane, 1,8-diaminooctane, 1,9-diaminononane and 1,10-diaminodecane, bis(2-ethylhexyl)amine, bis(2-methylhexyl)amine, diethylamine, triethylamine, cyclohexylamine, diethanolamine, triethanolamine, hydrogenated tallow-alkylamine, hydrogenated (tallow-alkyl)dimethylamine and hydrogenated bis(tallow-alkyl)methylamine.

As component (iv), the flux according to the invention comprises 0 to 20 wt. % of one or more components that differ from components (i) to (iii), i.e., the flux according to the invention may comprise one or more type (iv) components or be free thereof. Examples of type (iv) ingredients include in particular thickening agents, but may also include activators, defoamers, wetting aids and/or stabilizers. However, one advantage of the flux according to the invention that should not be underestimated can be that it does not necessarily require activators, i.e., it can also be formulated without activators.

Examples of thickening agents include ethyl cellulose, hydrogenated castor oil, glycerol-tris-12-hydroxystearin, polyamides and modified glycerol-tris-12-hydroxystearin.

Examples of low-molecular-weight carboxylic acids useful as activators include oxalic acid, adipic acid, malonic acid, succinic acid, glutaric acid, pimelic acid, cork acid, azelaic acid, sebacic acid, undecanedioic acid, dodecanedioic acid and tridecanedioic acid. To avoid misunderstandings, the diarboxylic acids mentioned here as examples relate to low-molecular-weight carboxylic acids deliberately added as a type (iv) component when formulating the flux according to the invention, not to be confused with any unintentional and unavoidable impurities in the flux according to the invention in the form of traces of carboxylic acids used as carboxyl building blocks in the synthesis of type (i) acidic oligoesters and not incorporated (not condensed) into the oligoester(s).

Examples of halogen-containing compounds useful as activators include aniline hydrochloride, glutamic acid hydrochloride, diethanolamine hydrochloride, diethanolamine hydrobromide, triethanolamine hydrochloride, triethanolamine hydrobromide and trans-2,3-dibromo-2-butene-1,4-diol.

The flux according to the invention is characterized by the fact that it undergoes a weight loss of ≥50 wt. % upon reaching a temperature of 280° C. during a TGA carried out in the range from 25 to 350° C. at a heating rate of 10 K/min and with the addition of synthetic air. Synthetic air is a gas mixture of 80 vol. % (% by volume) nitrogen and 20 vol. % oxygen. For the person skilled in the art, it is unnecessary to mention that said TGA usually works with a weight of flux according to the invention in the range of 10 to 30 mg. The weight loss observed in said TGA may be the result of evaporation and/or decomposition and/or oxidation. During the development of the flux according to the invention, it was found that the weight loss behavior described here can be significantly influenced by the choice of component (i) in terms of type and quantity; in this regard, the attention of the person skilled in the art is drawn in particular to the aforementioned statements regarding the type and quantity of component (i). There the person skilled in the art is given valuable suggestions for selecting the component (i).

Preferably, the flux according to the invention, i.e., the entire flux consisting of the components (i) plus (ii) or (i) plus (ii) plus (iii) or (i) plus (ii) plus (iv) or (i) plus (ii) plus (iii) plus (iv), has a flux acid number (FMSZ) in the range from 100 to 250 mg KOH/g, preferably in the range from 120 to 220 mg KOH/g. The flux acid number mentioned in this description and in the examples can be determined in accordance with IPC TM-650 2.3.13 (dated 06/2004 Revision A). The flux acid number is formed at least substantially or completely from the carboxyl groups of component (i) and the carboxyl groups optionally contributed by component (iv).

The invention consists in providing a solder paste comprising 80 to 92 wt. % of one or more different solders and 8 to 20 wt. % of a flux according to the invention, i.e., of a flux according to the invention in one of its aforementioned embodiments. The sum of the percentages by weight of the solder(s) and of the flux according to the invention is 100 wt. %.

As mentioned, the solder paste according to the invention comprises 80 to 92 wt. % of one or more different solders, in particular solder(s) based on tin (solder alloys comprising at least 80 wt. %, preferably at least 83 wt. %, in particular 90 to 99.5 wt. % tin) or based on bismuth/tin (solder alloys comprising 50 to 60 wt. % bismuth and 40 to 50 wt. % tin).

It is preferred that the solder has a liquidus temperature in a range from 150 to 350° C., preferably in a range from 180 to 300° C.

The solder or solders are present in the solder paste according to the invention as solder powder, as is usual for solder pastes. The ball size of the solder balls making up the solder powder can correspond to any of the classifications according to the IPC J-STD-005A standard, i.e., the solder paste according to the invention can have solder balls of any type of ball size within the type range T1 to T7.

Preferably, the solder paste according to the invention has a viscosity of 50 to 250 Pa·s. The viscosity mentioned in this description can be determined using a plate-plate rheometer having a plate diameter of 50 mm and a measuring gap of 400 μm (for example the plate-plate rheometer Physica MCR 150 from Anton-Paar) at 25° C. and at a shear rate of 10 s−1.

A further object of the present invention is a method for producing a solder paste according to the invention.

The method for producing a solder paste according to the invention comprises the following steps:
mixing the components of a flux according to the invention; and
adding a solder powder as mentioned above.

The solder powder is preferably added, in a plurality of portions while stirring, to a prepared mixture of the components of the flux according to the invention, generally without heating.

The solder paste according to the invention can be used to connect electronic components to substrates. It can also be used to produce solder deposits on substrates.

When connecting electronic components to substrates, the contact surface of the substrate and the contact surface of the electronic component are bonded via the solder paste according to the invention.

A method of attaching an electronic component to a substrate using a solder paste according to the invention may comprise the following steps:
a) providing an electronic component with a contact surface,
b) providing a substrate with a contact surface,
c) applying the solder paste to the contact surface of the electronic component and/or the contact surface of the substrate,
d) bonding the contact surface of the electronic component to the contact surface of the substrate using the solder paste; and
e) heating the solder paste above the liquidus temperature of the solder and then allowing the solder to cool and solidify, forming a firm bond between the electronic component and the substrate.

Steps a) and b) are self-explanatory and require no further explanation.

In step c), the solder paste according to the invention can be applied to one or both contact surfaces by means of conventional methods known to the skilled person, for example by screen or stencil printing or dispensing or jetting.

In step d), the contact surfaces of the electronic component and of the substrate can be bonded together using the solder paste. In other words, a sandwich arrangement can be created from the electronic component and the substrate, with the solder paste between the contact surfaces thereof.

In step e), the sandwich assembly can be soldered by heating the solder paste above the liquidus temperature of the solder so that a solid connection is formed between the electronic component and the substrate via the solder paste after the solder has cooled and solidified. The solder paste is preferably heated in such a way that the solder passes into its liquid phase, but without damaging the electronic component and/or the substrate. The sandwich assembly or rather the solder paste is preferably heated to a temperature that is 5 to 60° C., preferably 10 to 50° C., above the liquidus temperature of the solder.

The solder paste comprising the flux according to the invention is characterized by the formation of only a few cavities or no cavities in solder joints produced therefrom. As the aforementioned flux acid number of the flux according to the invention increases, in particular in the range from >120 to 220 mg KOH/g already mentioned as preferred, the solderability of the solder paste comprising the flux according to the invention improves in the presence of air.

### EXAMPLES

Example 1.1 (Preparation of an acidic oligoester from 1,4-cyclohexanedimethanol and o-phthalic acid): 100 g of 1,4-cyclohexanedimethanol and 150 g of o-phthalic acid were heated to 145° C. in a beaker with constant stirring until a clear and bubble-free composition was obtained. The resulting composition was then allowed to cool at room temperature. The acid number of the resulting oligoester was 215 mg KOH/g. The weight-average molecular weight Mw was 494.

Example 1.2 (Preparation of an acidic oligoester from glycerol and o-phthalic acid): 100 g glycerol and 150 g o-phthalic acid were heated to 145° C. in a beaker with constant stirring until a clear and bubble-free composition was obtained. The resulting composition was then allowed to cool at room temperature. The acid number of the resulting oligoester was 220 mg KOH/g. The weight-average molecular weight Mw was 508.

Example 1.3 (Preparation of an acidic oligoester from 2-ethyl-1,3-hexanediol and o-phthalic anhydride): 100 g of 2-ethyl-1,3-hexanediol and 150 g of o-phthalic anhydride were heated to 145° C. in a beaker with constant stirring until a clear and bubble-free composition was obtained. The resulting composition was then allowed to cool at room temperature. The acid number of the resulting oligoester was 210 mg KOH/g. The weight-average molecular weight Mw was 497.

### Preparation of Fluxes

Each of the acidic oligoesters from Examples 1.1, 1.2 and 1.3 was dissolved at 110° C. in diethylene glycol monohexyl ether according to Table 1. The mixture was then cooled to 80° C. and further ingredients were added and homogenized according to Table 1.

For all other fluxes, the components were combined and homogenized according to Table 1.

### Preparation of Solder Pastes

To prepare the solder pastes, 11 parts by weight of flux were mixed with 89 parts by weight of solder powder (SnAgCu: Sn 96.5 wt. %, Ag 3.0 wt. %, Cu 0.5 wt. %, type 4 according to the IPC J-STD-005A standard) to form solder pastes.

Thermogravimetric Analysis (TGA) of the Fluxes with Regard to Weight Loss Behavior

The thermogravimetric analysis was carried out using a thermobalance (TG 209 F1 Libra from Netzsch). For this purpose, a sample quantity of 10.0 mg of each of the fluxes listed in Table 1 was weighed into an aluminum oxide crucible. The TGA was carried out in synthetic air (80 vol. % nitrogen and 20 vol. % oxygen) at a heating rate of 10 K/min in the range from 25° C. to 350° C. The weight loss on reaching 280° C. was recorded.

### Determination of the Rate of Defects in the Soldering Point

To determine the void rate, five printed circuit boards (carrier material: FR4/contact surfaces: immersion tin) were printed over their entire surface with solder paste using stencil printing (X5 Professional from EKRA). The printing stencil had a thickness of 120 μm. The printed circuit boards were then fitted with two MLF48-6 mm dummy components each (Amkor 48LD/MLF 6×6 mm DC Sn) using a pick and place machine (Siplace X2 from Siemens) and subjected to a reflow process under normal atmospheric conditions. For this purpose, the assembled printed circuit boards were run through a reflow oven (VXS nitro 3150 type 634 from Rehm) at a speed of 76.5 cm/min with the following temperature settings: Zone 1: 150° C., Zone 2: 160° C., Zone 3: 175° C., Zone 4: 180° C., Zones 5 and 6: 200° C., Zone 7: 230° C., Zone 8: 255° C. and Zone 9: 265° C.

An AXI (automated X-ray inspection from Phoenix micromex GE PA1864) was used to evaluate the void rate among the dummy components. For this purpose, 2D X-ray images of the soldering points were taken and the proportion of trapped gas volume was analyzed. The arithmetic mean was given as a percentage of the total soldering area (contact area 4.6 mm×4.6 mm) and the results were assigned to the following void classes:
Void class:
+: <25%
−: ≥25 to <40%
—: ≥40%

### Testing the Wetting Capacity Under Normal Atmospheric Conditions

The wetting properties of the solder pastes were assessed using the melting test in accordance with the IPC-TM-650 (1/95) test method 2.4.45 under normal atmospheric conditions. For this purpose, the solder pastes to be tested were applied to copper sheets (20 mm×20 mm×0.5 mm). If the copper sheets had an oxide layer on the surface, they were sanded to a bright metallic finish with P600 grit sandpaper and cleaned with alcohol. Copper sheets which had a bright and clean surface were only cleaned with alcohol. The prepared copper sheets were printed using a stencil. To do this, the template was pressed firmly onto the copper sheet so that the openings in the template were in the middle of the copper sheet. The solder paste to be tested was placed on a Japanese spatula and spread over the openings of the stencil, first lightly and then with a little more pressure, until there was no more solder paste on the stencil. The stencil was then carefully removed while retaining the pattern defined by the stencil. The printed copper sheet was placed on a first heating plate, which was at 200° C. (i.e., set to a temperature below the liquidus temperature of the solder), for 2 minutes and then immediately placed on a second heating plate at a temperature 50° C. above the liquidus temperature of the solder. After the solder paste or solder had melted, the copper sheet was left on the second heating plate for another 5 seconds and then removed and cooled down.

After the solder paste had cooled, it was assessed whether it had melted into spots corresponding to the size of the openings in the stencil or into a plurality of small spots, and whether the solder paste had sharp edges after melting. It was also assessed whether the surface was glossy or matte.

The solder pastes were divided into four classes:
Class 1: The remelted area was larger than the area previously printed with solder paste.
Class 2: The remelted surface corresponded to the surface previously printed with solder paste.
Class 3: The remelted area was smaller than the area previously printed with solder paste (slight dewetting visible).
Class 4: The solder paste had formed one or more solder balls and had not wetted the copper sheet or had not completely melted.

TABLE 1
Composition of fluxes 1 to 7 according to the invention
and comparative fluxes V1 to V3, and measurement results

| Flux | 1 | 2 | 3 | 4 | 5 | 6 | 7 | V1 | V2 | V3 |
|---|---|---|---|---|---|---|---|---|---|---|
| Oligoester 1.1 | 60 | 50 | 40 | 50 | | | | | | |
| Oligoester 1.2 | | | | | 60 | | | | | |
| Oligoester 1.3 | | | | | | 60 | | | | |
| (Meth)acrylic copolymer | | | | | | | 40 | | | |
| (M_{w} 1800, SZ 244 mg | | | | | | | | | | |
| KOH/g) | | | | | | | | | | |
| (Meth)acrylic copolymer | | | | | | | | | 40 | |
| (M_{w} 4000, SZ 240 mg | | | | | | | | | | |
| KOH/g) | | | | | | | | | | |
| Colophony resin (M_{w} | | | | | | | | | | 40 |
| 375, SZ 150 mg KOH/g | | | | | | | | | | |
| Colophony resin (M_{w} | | | | | | | | 44 | | |
| 375, SZ 240 mg KOH/g) | | | | | | | | | | |
| Diethylene glycol | 27 | 37 | 47 | 27 | 27 | 27 | 35 | 35 | 43 | 40 |
| monohexyl ether | | | | | | | | | | |
| N,N,N′,N′- | 10 | 10 | 10 | 10 | 10 | 10 | 8 | 5 | 10 | 10 |
| tetramethylethylenediamine | | | | | | | | | | |
| Dodecanedioic acid | | | | 10 | | | 14 | 13 | 2.5 | 7 |
| Thickener (Disparlon 6500 | 3 | 3 | 3 | 3 | 3 | 3 | 3 | 3 | 4.5 | 3 |
| from King Industries) | | | | | | | | | | |
| Acid number of the flux | 156 | 135 | 113 | 183 | 162 | 152 | 165 | 190 | 133 | 99 |
| FMSZ (mg KOH/g) | | | | | | | | | | |
| Weight loss (%) at 280° C. | 75 | 80 | 85 | 60 | 70 | 65 | 50 | 40 | 35 | 40 |
| (TGA) | | | | | | | | | | |
| Void class | + | + | + | + | + | + | + | − | −− | − |
| Wetting capacity | 2 | 3 | 3 | 2 | 2 | 2 | 2 | 2 | 3 | 4 |

What is claimed is:

1. A flux consisting of:
(i) 30 to 80 wt. % of one or more acidic resins,
(ii) 10 to 60 wt. % of at least one organic solvent,
(iii) 0 to 15 wt. % of one or more amines, and
(iv) 0 to 20 wt. % of one or more components other than components (i) to (iii),
wherein the flux is characterized in that it undergoes a weight loss of ≥50 wt. % upon reaching a temperature of 280° C. during a thermogravimetric analysis carried out in the range from 25 to 350° C. at a heating rate of 10 K/min and with the addition of synthetic air.

2. The flux according to claim 1, wherein the one or more acidic resins are selected from the group consisting of acidic oligoesters and acidic (meth)acrylic copolymers.

3. The flux according to claim 2, wherein the acidic oligoester(s) and the acidic (meth)acrylic copolymer(s) are each carboxyl-group-bearing resins.

4. The flux according to claim 2, wherein the acidic oligoester(s) has/have an acid number in the range from 150 to 300 mg KOH/g and a weight-average molecular weight M_{w} in the range from 300 to 600.

5. The flux according to claim 4, wherein the acidic oligoester(s) has/have an acid number in the range from 200 to 250 mg KOH/g and a weight average molecular weight M_{w} in the range from 400 to 550.

6. The flux according to claim 2, wherein the acidic oligoester(s) is/are composed of one or more different low-molecular-weight polyols as hydroxyl building blocks and one or more different low-molecular-weight polycarboxylic acids as carboxyl building blocks.

7. The flux according to claim 2, wherein the acidic oligoester(s) is/are linear acidic oligoesters having one or two terminal carboxyl groups or a mixture of such oligoesters.

8. The flux according to claim 7, wherein the linear acidic oligoester(s) is/are composed of one or more different low-molecular-weight diols and one or more different low-molecular-weight dicarboxylic acids.

9. The flux according to claim 2, wherein the acidic (meth)acrylic copolymers have an acid number in the range from 100 to 350 mg KOH/g and a weight-average molecular weight M_{w} in the range from 1000 to 3500.

10. The flux according to claim 9, wherein the acidic (meth)acrylic copolymers have an acid number in the range from 150 to 300 mg KOH/g and a weight-average molecular weight M_{w} in the range from 1000 to 3000.

11. The flux according to claim 1 having a flux acid number in the range from 100 to 250 mg KOH/g.

12. A solder paste consisting of 80 to 92 wt. % of one or more different solders and 8 to 20 wt. % of a flux according to claim 1.

13. A use of a solder paste according to claim 12 for connecting electronic components to substrates or for producing solder deposits on substrates.
